(19) United States
(12) Patent Application Publication
(10) Pub. No.: US 2021/0374730 A1
(43) Pub. Date: Dec. 2, 2021

(54) DCF DECENTRALIZED IDS AND VERIFIABLE CREDENTIALS FOR PRODUCT DELIVERY INTO DATA CONFIDENCE FABRICS

(71) Applicant: EMC IP Holding Company LLC, Hopkinton, MA (US)

(72) Inventors: Stephen J. Todd, Center Conway, NH (US); Riaz Zolfonoon, Concord, MA (US)

(21) Appl. No.: 16/887,698

(22) Filed: May 29, 2020

(51) Int. Cl. G06Q 20/38; H04L 9/06; G06Q 20/06; G06Q 20/12

(52) U.S. Cl. CPC G06Q 20/3821; G06Q 20/12; G06Q 20/0658; H04L 9/0637

(57) ABSTRACT

One example method includes identifying user information associated with a user-specific decentralized identity (DID) of a first party, associating the user information with the DID, defining data terms that specify which user information may be shared, and under what circumstances, presenting the DID for verification by a second party that comprises a computing entity, receiving an indication that the DID has been verified by the computing entity, and based on verification of the DID, entering into a transaction with the second party, wherein the transaction comprises providing, to the computing entity, in accordance with the data terms, only user information that is needed by the computing entity to effect the transaction.

### FIELD OF THE INVENTION

Embodiments of the present invention generally relate to use of credentials for various transactions. More particularly, at least some embodiments of the invention relate to systems, hardware, software, computer-readable media, and methods for generating and using a user-owned decentralized identity.

### BACKGROUND

A DID document is an industry standard way for describing decentralized identities (DID) such as, for example, identities stored in a decentralized ledger as opposed to a centralized location like an AD (Active Directory) or LDAP (Lightweight Directory Access Protocol). DIDs may provide significant benefits to consumers. As well, DIDs may be employed in connection with VCs (Verifiable Credentials). However, a lack of support for DIDs and VCs is problematic.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a sale of data by a broker.

FIG. 2 discloses creation of a DID by a consumer.

FIG. 3 discloses a product order/delivery model leveraging DIDs.

FIG. 4 discloses consumer limits on personal attribute sharing during a transaction.

FIG. 5 discloses creation of a verifiable credential.

FIG. 6 disclose limited sharing of user data with other parties.

FIG. 7 discloses embedding DID metadata in a product.

FIG. 8 discloses use of DID metadata to join a DCF.

FIG. 9 discloses an example method for a transaction involving a DID.

FIG. 10 discloses an example computing entity.

### DETAILED DESCRIPTION OF SOME EXAMPLE EMBODIMENTS

Embodiments of the present invention generally relate to data backup and restore processes. More particularly, at least some embodiments of the invention relate to systems, hardware, software, computer-readable media, and methods for generating and using a user-owned decentralized identity, such as in a commercial context for example.

To illustrate, when purchasing products from high-tech companies, such as DellEMC for example, a customer may be required to create a vendor-specific identity to complete the purchase. At least some embodiments of the invention may employ an approach that enables the use of user-owned decentralized identities (DID), as well as verifiable claims based on these DIDs, to purchase products. Example embodiments may then embed these identities/claims into the shipping product to enable a set of data confidence fabric (DCF) features.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that they enable a consumer to control how much personal information, and what types, is disclosed to a vendor. One embodiment of the invention may enable a consumer to prohibit a vendor from sharing the consumer data with other parties, such as other vendors. An embodiment of the invention may enable a vendor to pre-configure a product, based on consumer input, that the product performs as expected when received by the consumer. An embodiment of the invention may enable a vendor to assign DIDs to products as they ship, which may make the products more attractive to consumers that employ a DID approach to their purchasing.

### A. Overview

The following is a discussion of aspects of some possible contexts for example embodiments of the invention. This discussion is not intended to limit the scope of the invention, or the applicability of the embodiments, in any way.

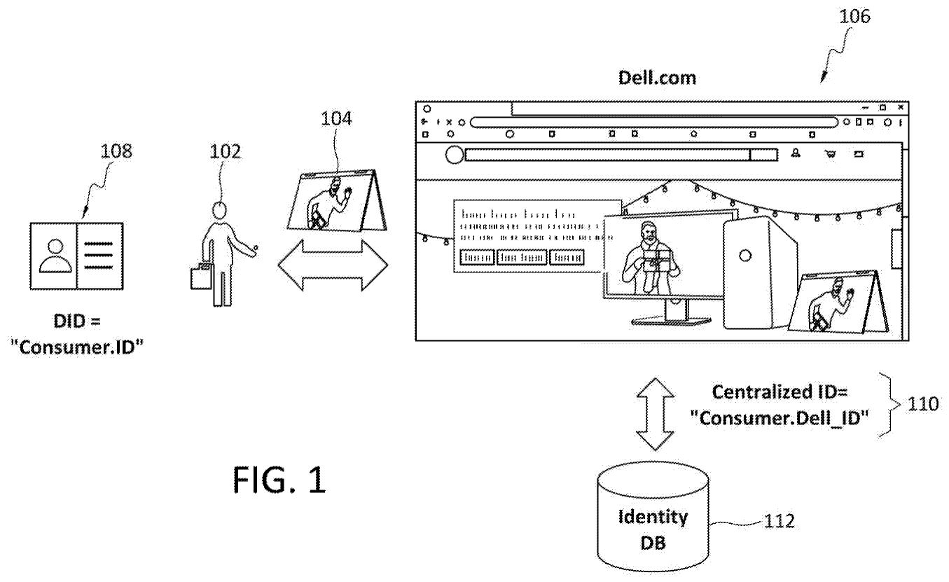

With particular reference to FIG. 1, an example transaction is disclosed in which a consumer 102 is purchasing a product 104, such as a laptop for example, from a vendor 106, such as DellEMC. In this illustrative example, the consumer may have already created, and owns, a public identity ‘Consumer.ID’ 110 which may be a DID. As shown, the ordering process, which may be driven by the vendor 108, requires the creation of a second identity 110 which may be a vendor-managed account such as ‘Consumer.Dell_ID’ that is specific to the vendor 108. As such, this second identity 110 may be referred to as a centralized identity since it emanates from a central location or entity, that is, the vendor 108. The second identity 110 may be stored in an identity database 112 that is owned, managed, and controlled, by the vendor 108. Depending upon any agreements between the consumer 102 and vendor 108, the vendor 108 may sell, or arrange the sale of, the identities in the identity database 112.

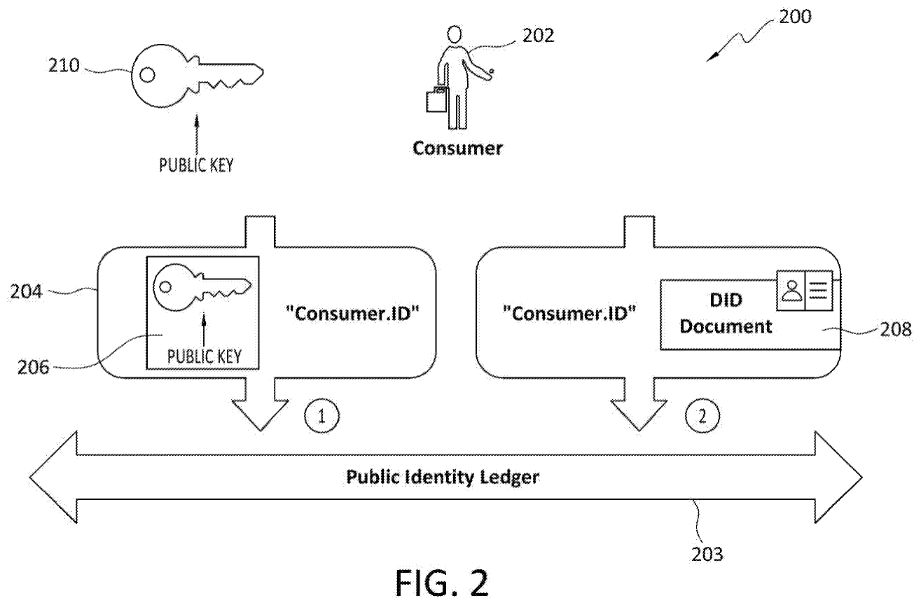

With reference now to FIG. 2, details are provided concerning an example process 200 by way of which a consumer 202 may create a DID 204. The example process 200 may take the form of a two-step commit process for the creation of a DID on a public ledger 203. Initially, the consumer 202 may choose an ID 204 such as ‘Consumer.ID’ for example, and then associate the ID 204 with a public key 206. Next, the consumer 202 may associate the ID 204 with some sort of pointer to an identity file 208 which may take the form of a verified document, such as a driver license for example, indicating the identity of the consumer 204. An entry, such as in a database, comprising the ID 204 and identity file 208 may be signed with the public key 206. A private key 210 held by an authorized party may be used to decrypt the encrypted entry.

With continued reference to FIGS. 1 and 2, it is noted that a DID document is an industry standard way for describing decentralized identities, that is, identities stored in a decentralized ledger, as opposed to being stored a centralized location like AD or LDAP such as may be employed by a vendor for example. DIDs can provide significant benefits to consumers, and they may be combined with VCs in some circumstances, as discussed elsewhere herein. As disclosed in FIG. 1 however, a lack of support for DIDs/VCs may be a significant disadvantage to their use, in some circumstances at least.

In general, requiring a customer, such as the example customers referred to in the discussion of FIGS. 1 and 2, to create a vendor-specific identity may give rise a variety of problems. To illustrate, as consumers continue to purchase multiple products, examples of which include high-tech products such as phones, televisions, and peripherals, for example, from multiple vendors, the consumer must maintain an ever-growing list of usernames and passwords, that is, identities, one for each vendor that the consumer deals with. Maintaining such a list is time-consuming, and the consumer must remember all the credentials for each vendor. This is the antithesis of a DID approach. It may be significantly simpler and more efficient for a user to be able to use and manage only a single identity that could be used across multiple vendors.

Another concern with an approach involving creation of multiple vendor-specific user accounts is that a consumer may provide false credentials during the account setup process. This may result in wasted resources for the vendor, such as generating mailings to fictitious or unused addresses, as well as potential fraud, such as when an unsuspecting consumer receives incorrect credit ratings due to the malicious actions of another user who provided false credentials.

It will also be appreciated that the creation of a centralized account allows a vendor to associate their product with the vendor-created identity of the consumer. While the consumer may have some level of control as to how much data is gathered about the consumer, the consumer must always provide some level of personal data in order to complete the sale. This process may be repeated for every vendor that the consumer interacts with.

Moreover, not only may a vendor gather personal data about a consumer during a sale, but it may also be the case that the vendor is sharing that data with other vendors. For example, the consumer shipping address is known by the vendor, and is also shared with a shipping partner of the vendor, such as FedEx or UPS for example. There may be little or nothing the consumer can do to prevent this data sharing by the vendor.

In another example, a user may wish to customize in some manner the operation of, for example, software and/or hardware that the user plans to purchase from a vendor. To illustrate, a consumer may wish to constrain the operation of the product that they purchase. For example, a consumer might specify that all data generated by the product for the consumer must be encrypted, or it must be securely stored at a location chosen by the consumer. However, there is no way for the consumer to specify this behavior during the purchase, and therefore there is no way to pre-configure the product to behave that way out-of-the-box, that is, as-received by the consumer. Thus, the consumer would be compelled to attempt to customize a generic product after the purchase, which may not be possible.

Moreover, vendors do not provide support for the DIDs of consumers who have them. Not only do many vendors lack support for DIDs, but they also lack the ability to help consumers create their own DID. However, a vendor that is able to help a customer protect their identity, and any data created in association with that identity, may realize a competitive advantage.

A final example of a possible problem that may be encountered in some identity programs is a lack of decentralized ID ‘product’ support. For example, many products, such as laptops, use traditional serial/model numbers. If these products could instead begin to identify themselves using a DID model, such an approach may allow DID consumers to begin managing their devices in a simpler and more consistent way.

### B. Aspects of Some Example Embodiments

While no embodiment of the invention is required to have any particular features or aspects, some example embodiments may have various different capabilities and functionalities. Examples of these are addressed in the following discussion.

In some embodiments, a DID may be recognized at the point of sale. Alternatively, a DID may be created by a vendor on behalf of the consumer, and this DID may subsequently be used at the point of sale.

Some embodiments may employ verifiable identities. Thus, any user attempting to use the DID will be asked to prove that he/she is in the possession of a corresponding private key so that users cannot easily be impersonated, as is possible with less sophisticated credentials such as simple UID/password combinations. Consumers may control the type and amount of their personal information that is disclosed to a vendor. Note that keys, such as a private key of a user, may be protected through hardware secure elements for a relatively stronger root of trust than if the key were not so protected. The private key may be supplied by the vendor in some cases.

In some embodiments, consumers may be able to prohibit a vendor, such as a primary vendor, from data-sharing with other vendors, such as secondary vendors with whom the consumer may have no direct interaction at the point of sale. In this way, such other vendors may be forced to communicate directly with the consumer to acquire personal details specific to the consumer.

Some embodiments may enable vendors to pre-configure their products, such as software and hardware for example, with DID terms and conditions. Because the pre-configuration may be based on input from the consumer, the product may behave as expected by the consumer out-of-the-box. In this way, a degree of customization is implemented in the product ultimately received by the consumer.

As a final example, some embodiments may enable vendors to assign DIDs to the products that the vendor ships. This approach may make the vendor product line more ‘friendly’ to consumers who are comfortable using DIDs and associated processes.

### C. Example Vendor Ordering/Delivery Architecture

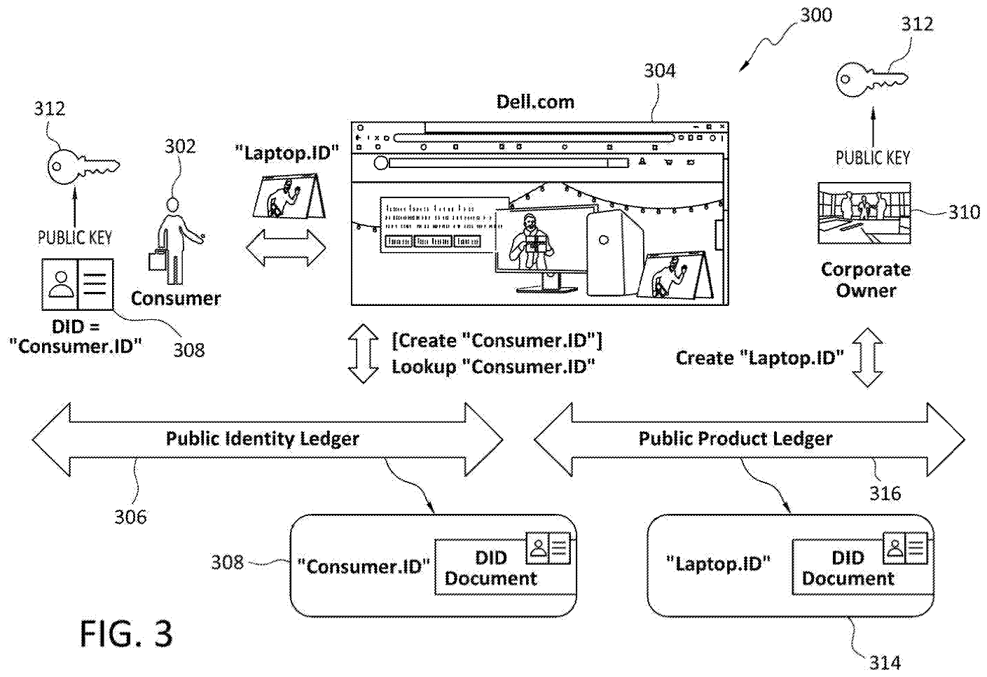

With particular reference now to FIG. 3, an example vendor ordering/delivery architecture 300 that may leverage DIDs is disclosed. Embodiments of this architecture 300 may have various features and functionalities. For example, such architecture 300 may provide for the acceptance and validation of DIDs. In particular, the consumer 302 may no longer be required to create a centralized, vendor-specific ID. Instead, the ordering website 304 is able to accept DIDs and consult a local ledger 306 to validate the identity 308 of the consumer 302. For example, the consumer 302 may ‘log on’ to the website 304 in a way that allows the vendor 310 to validate that the consumer 302 owns the appropriate private key 312. In response to the logon, or logon attempt, the vendor 310 may “Lookup ‘ConsumerID’” in the ledger 306, which may be a public identity ledger for example.

As further indicated in the example of FIG. 3, a vendor 310 may have to ability to create a DID 308 for a consumer 302 that does not already have a DID. This is indicated in FIG. 3 as “Create ‘ConsumerID’.” The newly created DID 308 for the consumer 302 may then be stored by the vendor 310 in the ledger 306. Creation of the DID 308 for the consumer 302 may involve stepping the consumer through a process of allocating and protecting their own private key 312. Assistance with the creation of a new DID may allow the consumer 302 to not only create a portable identity for use with other vendors but may also enable additional features as described elsewhere herein.

With continued reference to FIG. 3, embodiments of the invention may enable a vendor 310 to create a product ID 314 such as, for example ‘Laptop.ID.’ This creation of the product ID 314 may take place by way of a “Create ‘Laptop.ID’” process. Particularly, when a vendor 310 agrees to sell a product to a consumer 302, the vendor 310 may create a new DID for that product, and then register the product by storing the product ID 314 on a product ledger 316, which may take the form of a public product ledger for example.

### D. Controlled Sharing of Information

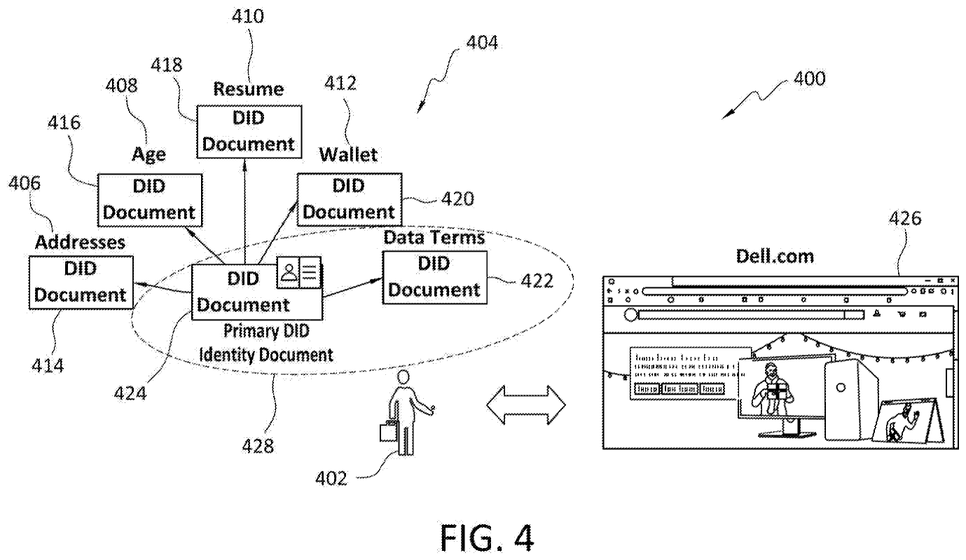

Directing attention now to FIG. 4, details are provided concerning further example aspects of some embodiments of the invention, where one illustrative configuration is denoted at 400. For example, and as indicated in FIG. 4, embodiments of the invention may provide a consumer 402 with the ability to share only data that is permitted to be shared by the consumer 402. As shown, the consumer 402 may have a variety of types of personal data 404 that the consumer 402 may wish to keep private. Such personal data 404 may include, for example, addresses 406, age information 408, a resume 410, and wallet information 412 which may include financial information personal to the consumer 402. Each of these types of information may be contained in a respective document 414, 416, 418, and 420 of the consumer 402. One or more of these documents 414, 416, 418, and 420 may contain terms 422 that govern how the data included in that particular DID will be handled in connection with any product purchased by the consumer 402. One or more of the documents 414, 416, 418, and 420 may be associated with a primary DID identity document 424 of the consumer 402. For example, one or more of the documents 414, 416, 418, and 420, may be included in the primary DID identity document 424. In some alternative embodiments, the primary DID identity document, or simply DID, 424 may include, instead of one or more of the documents 414, 416, 418, and 420, respective verifiable claims, credentials, or any other information that contains consumer attributes or other consumer-specific information.

While reference is made to documents 414, 416, 418, and 420, it should be understood that the scope of the invention is not limited to documents. For example, consumer attributes may be included in any element can be associated with the consumer DID. Thus, in other embodiments, consumer attributes may be included in a certificate, one example of which is a PKI certificate, that is associated with the consumer DID.

In more detail, the example of FIG. 4 discloses that the consumer 402 has created a DID 424 and associated a wide variety of attributes, relating to age, addresses, resume, and wallet in the illustrated example, with itself, that is, with the DID 424. Then, during a purchase process, the consumer 402 has full control over which personal attributes are shared with the vendor 426. In the illustrated example, the consumer 402 may share their DID 424 (‘ConsumerID’), and data terms 422 which specify how the consumer wishes their personal data to be treated, that is, post-purchase, by the product. The data terms 422 may be specified by the consumer 402, such as by way of a user interface for example, on an ad-hoc basis and may be updated by the consumer 402 at any time. The data terms 422 may be product and/or vendor-specific. There may be a copy of the data terms 422 at the vendor 426 site so that when the user logs in to make purchase, the data terms 422 associated with the credentials of that user are automatically applied to the product(s) purchased by the consumer 422. The consumer 402 may specify, such as by way of a menu for example, the data terms 422 at the time of purchase. More generally, the data terms 422 may be defined, selected, and modified, in any way that enables them to be associated with a product that the consumer 402 has purchased.

The data terms 422 may specify a wide variety of constraints and parameters with respect to, for example, consumer data associated with a product purchased by the consumer. Thus, example data terms 422 may include, but are not limited to, any one or more of: any data captured by this product must be stored digitally signed; any data captured by this product must be stored onto my personal data portal; any data captured by this product must be encrypted when moved off of the device; and, all data generated by this product must be registered with a specific Data Confidence Fabric (DCF). Note that with respect to the latter term, the DCF may track the provenance and trust handling of new data, as well as assign a data confidence score to any generated data.

In the particular example of FIG. 4, the consumer 402 may hide certain attributes from the vendor 426, such as when the consumer 402 deems that the vendor 426 does not need this information for a transaction with the consumer 402. Thus, in FIG. 4, only a subset 428 of the personal data 404 is shared by the consumer 402 with the vendor 426, and other data, such as addresses 406, age 408, resume 410, and wallet 412, are not shared with the vendor 426. Of course, the vendor 426 may complete the transaction, or not, depending upon whether the vendor 426 receives the information that it has requested from the consumer 402. The personal data 404 that is shared may be a function of the nature of the vendor. For example, if the vendor 426 were a shipping company, then it may be necessary for the consumer 402 to provide addresses 406 to the shipping company so that the shipping company knows where to send a purchased product.

### E. Use of Verifiable Credentials With Partners

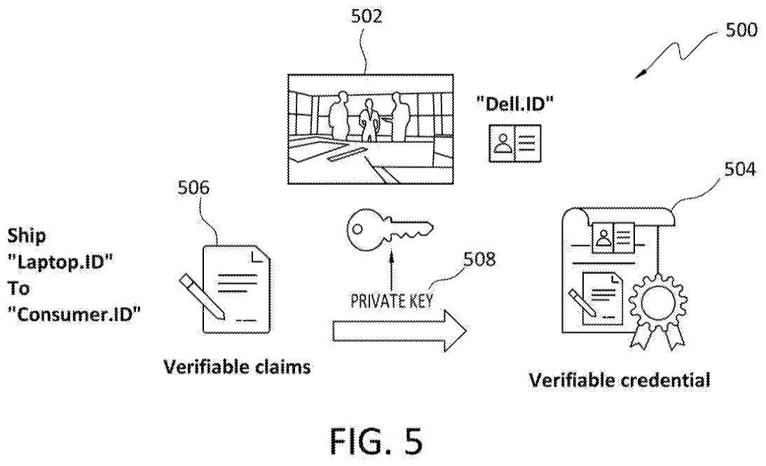

Turning next to FIG. 5, an arrangement 500 is disclosed in which a vendor 502, possibly having agreed to sell a product to a consumer, needs a shipping address for the consumer. In the interest of providing personal information only to those parties with a demonstrable need for it, the consumer may wish to withhold its address from the vendor 502, but that information will be needed by the shipping company.

In one example approach to circumstances such as these, the consumer may agree to allow the vendor 502, having a DID such as ‘DELL.ID’ for example, to share product details with a shipping company. When the vendor 502 creates a new Product.ID, such as ‘Laptop.ID’ for example, the vendor 502 may then also create verifiable credentials 504 that contract with a specific shipping company to deliver the product to the consumer. As used herein, ‘verifiable credentials’ embrace, among other things, a set of verifiable claims 506 concerning the user and that are tamper evident, and metadata that cryptographically prove who issued the verifiable credential.

The metadata in a verifiable credential 504 may be information about the credentials of the owner along with proof, such as a digital signature for example, about who created the verifiable credential 504. In the example of FIG. 5, a vendor 502 with DID ‘Dell.ID’ has created a verifiable credential 504 that gives permission to ship a product bearing the DID ‘Laptop.ID’ to a consumer whose DID is ‘Consumer.ID.’ The example verifiable credential depicted in FIG. 5 comprises the following information: metadata about the issuer of the credential, that is, the vendor 502; a list of verifiable claims 506 regarding the shipment of the laptop; and, proof that the issuer, the vendor 502 in this case, created the credential, for example, showing that the verifiable claims 506 were signed with a private vendor key 508 to generate the verifiable credential 504.

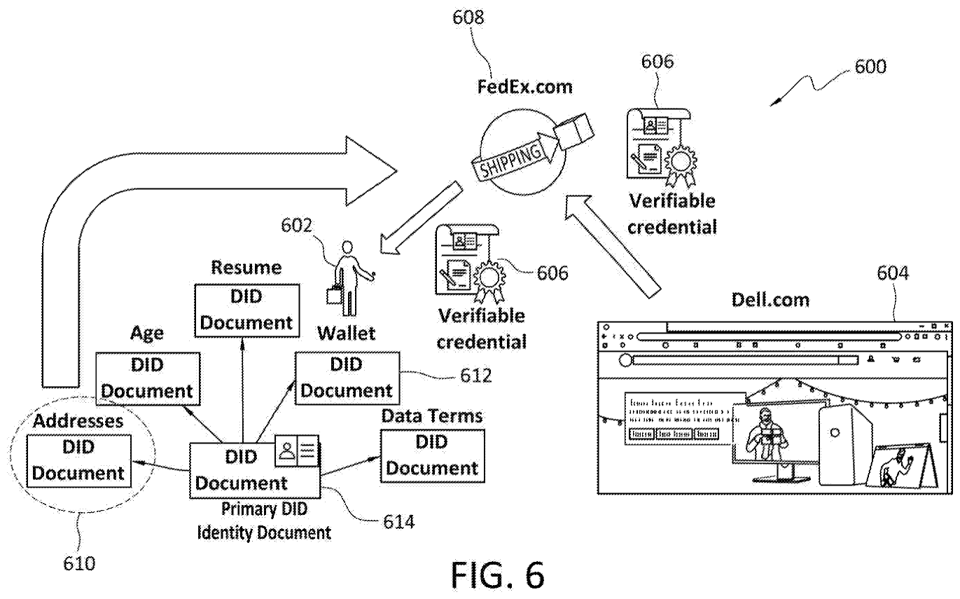

Turning next to FIG. 6, further information is provided concerning an example circumstance or configuration 600 in which a consumer 602 or other user may be interacting with multiple parties in connection with a transaction. In the example of FIG. 6, there are three parties involved with one or more transactions. The scope of the invention is not limited to any number of parties, nor to any particular type or number of transactions. Thus, the configuration 600 disclosed in FIG. 6 is provided only by way of illustration and is not limiting of the scope of the invention in any way.

In particular, after a vendor 604 or other entity interacting with a user such as a consumer 602 has created a verifiable credential 606, the vendor 604 may then contact another entity such as a shipping company 608 to arrange for shipment of the product to the consumer 602. Thus, the example of FIG. 6 discloses a three-way exchange involving a consumer 602, vendor 604, and shipping company 608.

In this example, and as explained below, the consumer 602 may share a first set of information with the vendor 604, and a second set of information with the shipping company 608. These two sets of information may, or may not, include some information common that is common to both sets, such as the consumer name for example. Some information, such as a shipping address 610, is shared by the consumer 602 with one party, the shipping company 608, but is not shared with the other party, that is, the vendor 604. Likewise, payment information, for example, may be shared with the vendor 604 but may not be shared with the shipping company 608. Thus, embodiments of the invention may enable a party, using a DID, to share with one or more other parties, only the information necessary. Information not needed by a party, in connection with a transaction for example, such as the age of a consumer, may not be shared with that party by the owner of the information. Put another way, the consumer may share consumer-specific and/or other confidential information with one or more other parties only on a need-to-know basis.

In more detail, and as disclosed in FIG. 6, the vendor 604 may share the verifiable credential 606 with the shipping company 608. The shipping company 608 may extract the consumer identity from the verifiable credential 606, then contact the consumer 602 and ask for the address 610 to which to send the product. The consumer 602 may validate that the vendor 604 has granted permission to the shipping company 608 by inspecting the verifiable credential 606 that was issued by the vendor 604 and then provided by the shipping company 608 to the consumer 602. The shipping company 608 may contact the consumer 602 using suitable method, such as, for example publication of a service endpoint about how to contact the consumer 602. Once the shipping company 608 has proved to the consumer 602 that the shipment request is legitimate, the address 610 of the consumer 602 may be shared by the consumer with the shipping company 608 but need not, and may not, be shared with the vendor 604. Thus, the verifiable credential 606, more generally, enables the consumer 602 to share specified consumer-specific information with one or more parties selected by the consumer 602.

Some further use cases involving transactions concern consumer wallets 612 and smart contracts. For example, the use of DID technologies such as those disclosed herein may allow the consumer 602 to associate a cryptocurrency wallet or other wallet 612 with their identity, that is, their Primary DID Identity Document 614. This approach may allow a vendor 602 to receive payment immediately, such as via a distributed ledger technology for example, since the consumer 602 may be able to verify the vendor 604 by looking up an entry in the distributed ledger. The DID technologies may also enable ‘smart contracts’ to be agreed to by multiple parties, such as between the consumer-vendor, vendor-shipping company, and shipping company-consumer.

### F. Embedding DID Metadata into Products

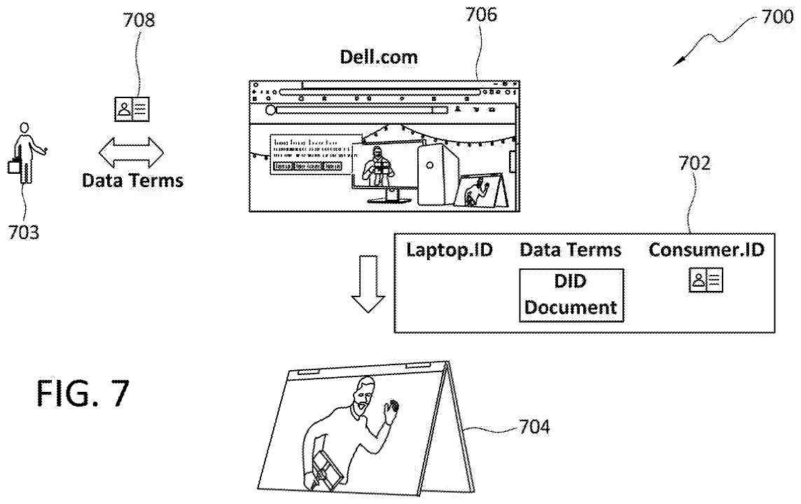

As noted earlier herein, some embodiments may provide the ability, such as on the part of a vendor for example “bake in” to a product identity information given to the vendor by the consumer. For example, FIG. 7 discloses a configuration 700 involving the storage of consumer identity information 702 of a consumer 703 into a laptop 704, by a vendor 706. Similarly, the consumer identity, or DID, information 702 may be loaded into software or other products. In addition to the consumer identity information 702, data terms 708 specified by the user may also be stored in a laptop 704, software, and/or other products.

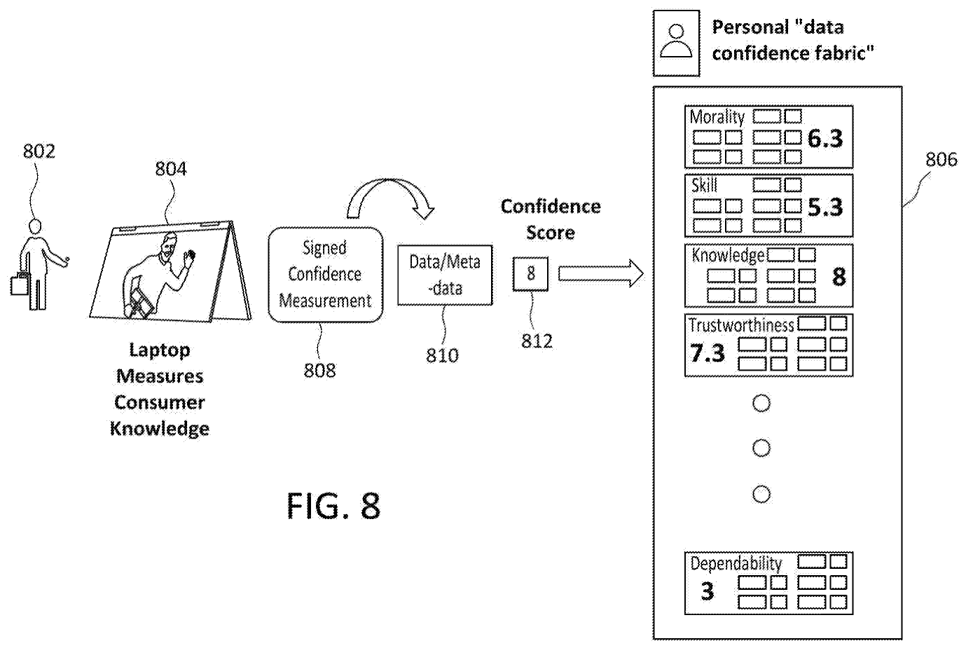

When the device, software, or other product, is first used by the consumer, the product is aware of the identity of the consumer, due to the embedding of the consumer DID 703 information, and the initial data terms 708 that the consumer 702 has mandated for that product to perform. As explained in the following discussion of FIG. 8, the consumer 703 may use the device, such as laptop 704, to measure trustworthiness as part of a data confidence fabric (DCF).

The example configuration 800 of FIG. 8 concerns a situation in which a consumer 802 owns a product, such as a laptop 804, with embedded DID metadata. The laptop 804 may have a DID ‘Laptop.ID.’ In this example, when the laptop 804 is received by the consumer 802 and is powered on, the laptop 804 may be instructed to join a specific DCF 806 that the consumer uses to measure their own trustworthiness. Some or all of the data generated, received, and/or, stored, by the laptop 804, such as data received from the consumer 802 for example, may be digitally signed by the laptop 804 and then stored at a secure location and/or elsewhere, as may be dictated by data terms specified by the consumer 802. That is, by signing the data, the laptop 804 may generate a signed confidence measurement 808 that is associated with, and/or causes the generation of, trust metadata 810. The trust metadata 810 in turn, may correspond to, or imply, a particular confidence score 812 concerning the data, and the confidence score 812 may be transmitted by the laptop 804 to the DCF 806. In this way, the DCF 806 may reflect one or more particular attributes of the user associated with the data that was the basis for the confidence score 812. As shown in FIG. 8, the confidence scores 812 may inform any of a variety of personal, and/or, other, user attributes. To briefly illustrate with another example, a confidence score 812 may reflect the competence of the user with regard, for example, to one or more programs installed on the laptop 804.

Note that it may be the case that multiple users may share a single device, such as the laptop 804. In this case, the laptop 804 may store multiple DIDs and independently authenticate each user for each session when the user logs in. Such a situation may arise, for example, with respect to an operator console for an industrial system, where different operators use the industrial system on a rotating basis or shift. In this way, a separate respective trust context may be maintained for each user and may reflect the activities of the use with respect to their operation of the system. For example, if the user does not operate the system properly, such as by overriding safety features, one or more user attributes such as skill, knowledge, trustworthiness, or dependability, may suffer from reduced confidence scores.

Thus, as exemplified herein, embodiments of the invention may enable a user, such as a consumer to bring their own protected identity, such as a decentralized identity (DID), to transactions and other processes to enable various functionalities. Moreover, embodiments may leverage DID capabilities, such as verifiable credentials, and embed various information into products to enhance the user experience, while also respecting the wishes of the consumer with respect to the handling and management of personal user data and/or other confidential data.

### G. Example Methods

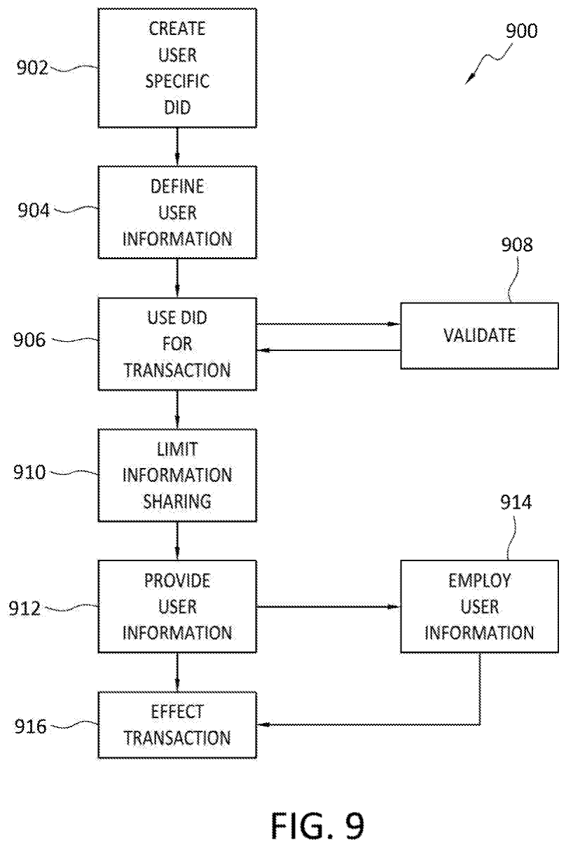

Attention is directed now to FIG. 9, where an example method for creation and use of a DID are disclosed. It is noted with respect to the example method of FIG. 9, as well as to any of the other disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

The example method 900 may be performed in whole or in part by a single party, or cooperatively by multiple parties. In some embodiments, the method 900 may be cooperatively performed by a multiple parties that include a consumer, and a vendor. The scope of the invention is not limited to performance of the method 900, or any portion thereof, by any particular party or parties.

The example method 900 of FIG. 9 may begin when a DID is created 902 that is specific to a particular party, such as a consumer for example. The DID may be created 902 by any party. In some cases, the DID may be created by the consumer while, in other cases, the DID may be created 902 by a party other than the consumer, such as a vendor of goods and/or services for example. In some embodiments, the DID may be signed with a private key, such as the private key of a user for example. The DID may be universal, or decentralized, in the sense that it can be employed by the user with a variety of other parties. Thus, the DID may eliminate the need for the user to create different respective IDs for each party with whom the user may interact.

Before, during, or after, the creation 902 of the DID, various user information may be defined for association 904 with the DID. In at least some embodiments, such user information may be information specific to the user, confidential information, or some combination of these. The user information may include, for example, information that a user may need to effect a commercial transaction involving one or more other parties.

After the DID has been created 902, and user information associated with the DID 904, the user may present the DID 906 in connection with an anticipated transaction with one or more other parties. Examples of such transactions are disclosed herein and may involve one or more parties in addition to the user. Thus, such transactions may be 2-way transactions (2 parties involved), 3-way transactions (3 parties involved), or X-way transactions (‘X’ parties involved). A transaction may involve, for example, presentation by the user of the DID to a vendor, and verification, by the vendor of the DID such as by way of a ledger for example. Upon verification, the user may enter a transaction with the vendor.

Note that as used herein, a ‘transaction’ is not limited to commercial transactions between, for example, a user and vendor. Rather, ‘transaction’ embraces, among other things, any interaction between parties which involves the presentation 906 by one party of a DID for validation 908 as a prerequisite for engaging with a validating party. Thus, a transaction may involve, for example, simply an exchange of information between parties, where the information is not exchanged absent validation of a presented DID.

In connection with an actual or contemplated transaction, one or more of the parties to the transaction may wish to limit 910 the information that will be provided by that party to the other party, or parties, to the transaction. This limitation on information sharing 908 may be based on data terms that specify whether, and under what circumstances, one or more pieces of information associated with a party may be disclosed to another party. In this way, a party may disclose its information only on a need-to-know basis to another party, or parties. The data terms may be defined by the party to whom the information pertains, and may be associated with the DID of that party. The data terms that control information sharing 910 may be modified at any time by the party to whom they pertain, and/or may be modified by an authorized agent of that party. Data terms may be created and/or applied on an ad hoc basis, or may be persistent over multiple transactions. In some instances, a copy of the data terms may be provided to the vendor.

When the limitations on information sharing 910 are applied, permitted data may then be provided 912 by one party, such as a consumer for example, to another, such as a vendor for example. A party to the transaction, such as a vendor for example, may receive the user data provided 912 in accordance with the vendor terms and may employ the user data 914 to effect a transaction 916 with the party that submitted the DID and information. Such a transaction 916 may involve, for example, vendor customization of a product purchased by a consumer. For example, the data terms may specify that consumer-specific information should always be encrypted by a laptop that the consumer purchases from the vendor. In this way, when the consumer receives the laptop, the consumer has assurance that specified consumer information put onto the laptop will be encrypted.

### H. Further Example Embodiments

Following are some further example embodiments of the invention. These are presented only by way of example and are not intended to limit the scope of the invention in any way.

Embodiment 1. A method, comprising: identifying user information associated with a user-specific decentralized identity (DID) of a first party; associating the user information with the DID; defining data terms that specify which user information may be shared, and under what circumstances; presenting the DID for verification by a second party that comprises a computing entity; receiving an indication that the DID has been verified by the computing entity; and based on verification of the DID, entering into a transaction with the second party, wherein the transaction comprises providing, to the computing entity, in accordance with the data terms, only user information that is needed by the computing entity to effect the transaction.

Embodiment 2. The method as recited in embodiment 1, wherein the DID is created by the first party.

Embodiment 3. The method as recited in any of embodiments 1-2, wherein the DID is created by the computing entity at the request of the first party.

Embodiment 4. The method as recited in any of embodiments 1-3, wherein verification of the DID is confirmed by the presence, in a public identity ledger, of the DID.

Embodiment 5. The method as recited in any of embodiments 1-4, wherein the transaction involves the purchase of goods by the first party by way of a website of the computing entity.

Embodiment 6. The method as recited in embodiment 5, wherein the goods include embedded DID metadata that is consistent with the data terms.

Embodiment 7. The method as recited in any of embodiments 1-6, wherein the DID is not limited for use with any particular second party.

Embodiment 8. The method as recited in any of embodiments 1-7, wherein the first party uses the data terms to prohibit the computing entity from sharing the user information with another party.

Embodiment 9. The method as recited in any of embodiments 1-8, wherein the DID is signed with a private key of the first party.

Embodiment 10. The method as recited in any of embodiments 1-9, wherein verification of the DID confirms that a private key held by the first party is valid.

Embodiment 11. A method for performing any of the operations, methods, or processes, or any portion of any of these, disclosed herein.

Embodiment 12. A non-transitory storage medium having stored therein instructions that are executable by one or more hardware processors to perform the operations of any one or more of embodiments 1 through 11.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

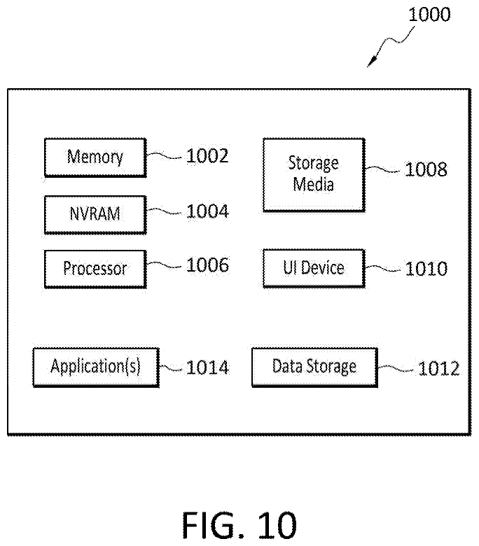

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile random access memory (NVRAM) 1004, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying user information associated with a user-specific decentralized identity (DID) of a first party;
associating the user information with the DID;
defining data terms that specify which user information may be shared, and under what circumstances;
presenting the DID for verification by a second party that comprises a computing entity;
receiving an indication that the DID has been verified by the computing entity; and
based on verification of the DID, entering into a transaction with the second party, wherein the transaction comprises providing, to the computing entity, in accordance with the data terms, only user information that is needed by the computing entity to effect the transaction.

2. The method as recited in claim 1, wherein the DID is created by the first party.

3. The method as recited in claim 1, wherein the DID is created by the computing entity at the request of the first party.

4. The method as recited in claim 1, wherein verification of the DID is confirmed by the presence, in a public identity ledger, of the DID.

5. The method as recited in claim 1, wherein the transaction involves the purchase of goods by the first party by way of a website of the computing entity.

6. The method as recited in claim 5, wherein the goods include embedded DID metadata that is consistent with the data terms.

7. The method as recited in claim 1, wherein the DID is not limited for use with any particular second party.

8. The method as recited in claim 1, wherein the first party uses the data terms to prohibit the computing entity from sharing the user information with another party.

9. The method as recited in claim 1, wherein the DID is signed with a private key of the first party.

10. The method as recited in claim 1, wherein verification of the DID confirms that a private key held by the first party is valid.

11. A non-transitory storage medium having stored therein instructions that are executable by one or more hardware processors to perform operations comprising:
identifying user information associated with a user-specific decentralized identity (DID) of a first party;
associating the user information with the DID;
defining data terms that specify which user information may be shared, and under what circumstances;
presenting the DID for verification by a second party that comprises a computing entity;
receiving an indication that the DID has been verified by the computing entity; and
based on verification of the DID, entering into a transaction with the second party, wherein the transaction comprises providing, to the computing entity, in accordance with the data terms, only user information that is needed by the computing entity to effect the transaction.

12. The non-transitory storage medium as recited in claim 11, wherein the DID is created by the first party.

13. The non-transitory storage medium as recited in claim 11, wherein the DID is created by the computing entity at the request of the first party.

14. The non-transitory storage medium as recited in claim 11, wherein verification of the DID is confirmed by the presence, in a public identity ledger, of the DID.

15. The non-transitory storage medium as recited in claim 11, wherein the transaction involves the purchase of goods by the first party by way of a website of the computing entity.

16. The non-transitory storage medium as recited in claim 15, wherein the goods include embedded DID metadata that is consistent with the data terms.

17. The non-transitory storage medium as recited in claim 11, wherein the DID is not limited for use with any particular second party.

18. The non-transitory storage medium as recited in claim 11, wherein the first party uses the data terms to prohibit the computing entity from sharing the user information with another party.

19. The non-transitory storage medium as recited in claim 11, wherein the DID is signed with a private key of the first party.

20. The non-transitory storage medium as recited in claim 11, wherein validation of the DID confirms that a private key held by the first party is valid.
